(19) United States
(12) Patent Application Publication
(10) Pub. No.: US 2026/0153374 A1
(43) Pub. Date: Jun. 4, 2026

(54) ELECTRIC FILL LEVEL GAUGE

(71) Applicant: Endress+Hauser SE+Co. KG, Maulburg (DE)

(72) Inventors: Lars Stolz, Eimeldingen (DE); Robert Schmidt, Schopfheim (DE); Gerd Bechtel, Steinen (DE)

(21) Appl. No.: 18/720,703

(22) PCT Filed: Nov. 22, 2022
(86) PCT No.: PCT/EP2022/082750

§ 371 Date: Feb. 11, 2026

(30) Foreign Application Priority Data
Dec. 17, 2021 (DE) 10 2021 133 767.4

(51) Int. Cl. G01F 23/263; G01F 23/28

(52) U.S. Cl. CPC G01F 23/268; G01F 23/282

(57) ABSTRACT

The invention relates to an electric fill level measuring device (1) for measuring a fill level of a medium in a containment, comprising:
an electrically conductive probe (10);
an electronic measuring/operating circuit (20);
a housing (30);
secured to the housing, a process connection (40);
wherein the probe is supported radially by the process connection by means of a conical seal (50),
wherein the conical seal is compressed between a conical interior surface and the probe,
wherein a spring mechanism (60) is adapted to compress the conical seal by exerting a force on the conical seal in the direction of the open end,
the probe has a first probe part (11) and a second probe part (12), which probe parts are joined together, wherein the first probe part is arranged in the lumen and provides an engagement surface (11.1) for the spring mechanism, and wherein the second probe part is adapted to be immersed in the medium.

The invention relates to an electric fill level measuring device, or gauge, in the case of which a probe is immersed in a medium located in a containment and a fill level of the medium is derived via electric properties.

Such fill level measuring devices are known from, for example, EP1544585B1. In order that an effective sealing of such fill level measuring devices is obtained, conically formed seals are applied, which, however, in the state of the art are only safely installed via complicated apparatuses.

An object of the invention is to provide a fill level measuring device having an easy and safe apparatus for securing and holding a conical sealing element.

The object is achieved by a fill level measuring device as defined in independent claim 1.

An electric fill level measuring device of the for measuring a fill level of a medium in a containment comprises:
an electrically conductive probe adapted for conducting an electric signal, wherein the probe is adapted to be immersed in the medium;
an electronic measuring/operating circuit adapted for producing and evaluating electric signals as well as for providing fill level measured values;
a housing, in which, for example, the electronic measuring/operating circuit is arranged;
secured to the housing, a process connection, which is adapted to support the probe radially, wherein the probe extends sectionally inwardly via an open end of the process connection into a lumen of the process connection;
wherein the probe is supported radially by the process connection by means of a conical seal,
wherein an interior surface of the process connection in the region of the open end has a conical form, wherein an inner diameter decreases toward the open end, wherein the conical seal is compressed between the conical interior surface and the probe,
wherein a spring mechanism is adapted to provide the compression of the conical seal by a force acting on the conical seal in the direction of the open end, wherein the probe has a first probe part and a second probe part, which probe parts are joined together, wherein the first probe part is arranged in the lumen and provides an engagement surface for the spring mechanism, and wherein the second probe part is adapted to be immersed in the medium.

In this way, an easy and robust mechanical construction is accomplished, by means of which the conical seal is held safely and lastingly.

In an embodiment, the first probe part is a mechanically strong part, for example, a turned part,
wherein the second probe part is a rod or a cable.

In an embodiment, the second probe part has, at least sectionally, an electrically insulating coating, especially an extruded plastics coating.

In an embodiment, the electronic measuring/operating circuit is adapted to derive the fill level of the medium from a measured electric current, or a measured capacitance or a signal travel time of an electric pulse.

In an embodiment, the first probe part and the second probe part are welded together.

In an embodiment, the first probe part has a socket for the second probe part, which grips the second probe part in an end region of the second probe part.

In an embodiment, the socket provides the engagement surface on a side facing the second probe part.

In an embodiment, the first probe part is supported radially by the process connection, especially free of play, by means of a plastic part.

In an embodiment, the first probe part has sectionally a conical exterior surface, wherein the plastic part has a corresponding conical interior surface, wherein the exterior surface and the interior surface bear against one another by means of a force action.

In an embodiment, the electronic measuring/operating circuit is connected with the first probe part by means of an electrically conductive clamping apparatus.

The invention will now be described based on examples of embodiments of the invention presented in the appended drawing, the figures of which show as follows:

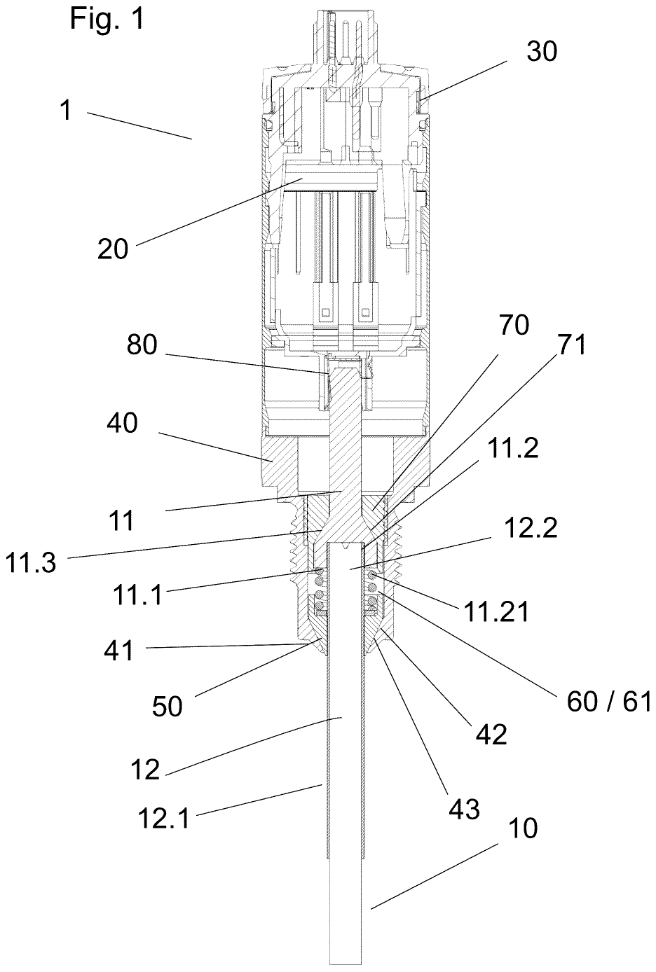

FIG. 1 a longitudinal section through an example of a fill level measuring device of the invention; and

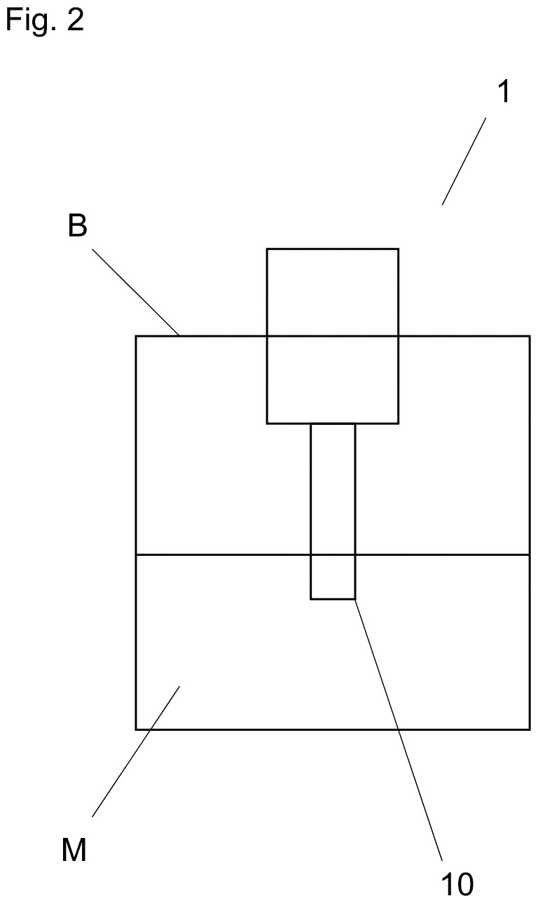

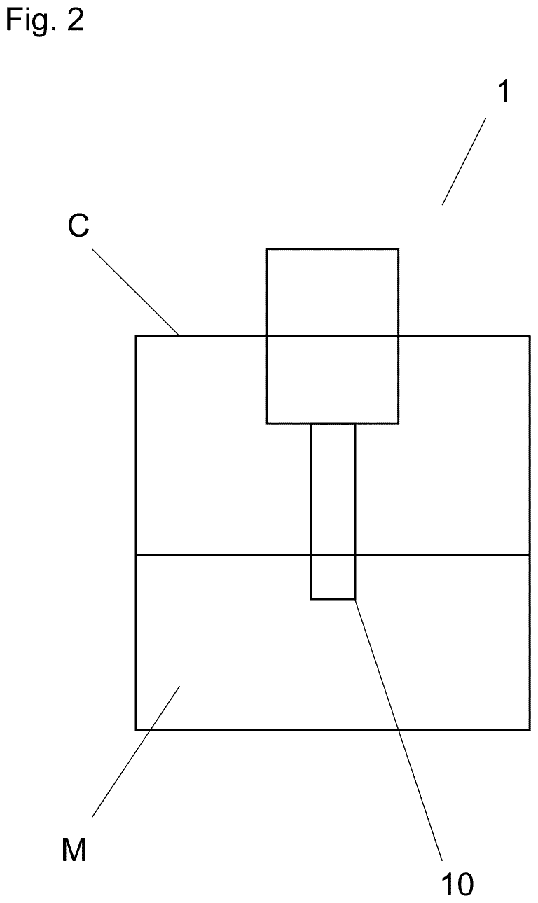

FIG. 2 a measurement structure including a fill level measuring device and a containment.

FIG. 1 shows a longitudinal section of an example of a fill level measuring device 1 of the invention with a housing 30, an electronic measuring/operating circuit 20 arranged in the housing, an electrically conductive probe 10, and a process connection 40.

Alternatively, the electronic measuring/operating circuit can also be arranged outside of the housing and electrically connected with the probe by means of an interface.

The process connection is secured to the housing and adapted to hold the probe 10 radially. The probe extends, in such case, via an open end 41 of the process connection into a lumen 42 of the process connection. An interior surface 43 of the process connection has a conical form in the region of the open end. A correspondingly conical seal 50 is compressed between the interior surface and the probe 10. In this way, the probe is held radially by the process connection.

In order to assure a solid seating of the conical seal, a spring mechanism 60 embodied, for example, such as shown here, by means of a helical spring 61, effects a force on the conical seal in the direction of the open end.

According to the invention, the probe has a first probe part 11 and a second probe part 12, which probe parts are joined, for example, by welding, and, especially, by spot welding. The first probe part is rod shaped and rigid. The second probe part can, such as shown here, likewise be rigid and rod shaped. Alternatively, the second probe part can have a cable on its medium facing end, whereby a region contacting the medium can be mechanically flexible. The first probe part is arranged in the lumen of the process connection and is electrically connected with the electronic measuring/operating circuit. The first probe part offers, in such case, an engagement surface 11.1 for the spring mechanism 60, in order that such can effect a force on the conical seal. For example, the first probe part can, such as shown here, have a socket 11.2 for an end region 12.2 of the second probe part 12, wherein a second probe part directed side 11.21 of the socket has the engagement surface. The second probe part is, in such case, adapted to be immersed sectionally in the medium.

For example, the first probe part, such as shown here, is a rigid component and can be made, for example, by turning a workpiece. The second probe part can have sectionally an electrically insulating coating 12.1. Such can be, for example, an extruded plastics coating.

The first probe part can, such as shown here, be supported radially by the process connection by means of a plastic part 70. The first probe part can, in such case, such as shown here, have a sectionally conical exterior surface 11.3, wherein the plastic part has a corresponding conical interior surface, which conical surfaces can be caused to bear against one another by means of a force action.

The electric connecting of the electronic measuring/operating circuit 20 to the probe can, such as shown here, be effected by means of an electrically conductive clamping apparatus 80, which is clamped, for example, on an end region of the rod shaped, first probe part.

In an embodiment, the conical seal comprises an elastomer or thermoplastic and/or is made of an elastomer or thermoplastic.

FIG. 2 shows a measurement structure with an example of a fill level measuring device 1 of the invention and a containment B, in which a medium M is located. The probe 10 of the fill level measuring device is immersed, in such case, sectionally in the medium.

Electrical properties of the probe, or probe, medium and, in given cases, containment, depend on immersion depth of the probe, and, thus, on the fill level of medium. A retrieval of these properties can, thus, be utilized to determine the fill level of a medium.

For example, an electric conductivity of probe, medium and containment can be used to determine a limit level of the medium. For example, this conductivity can be retrieved by a measured electric current in the case of given measurement voltage or by an electric resistance measurement.

For example, also an electric capacitance between medium and probe can be ascertained. This capacitance is greater with greater immersion depth. For example, by determining a resonant frequency of an electric signal, with which the probe is supplied, the capacitance can be determined and, thus, the immersion depth, or the fill level of the medium. For example, the capacitance can also be determined by supplying the probe with an alternating electric current and measuring a phase shift between a measured voltage and a measured electric current. A reactive electric current derivable therefrom leads to the capacitance between medium and probe.

For example, the probe can be supplied with an electric pulse, which propagates on a lateral surface of the probe and is reflected at an air-medium interface. A travel time to the interface and back leads to the fill level of the medium.

### LIST OF REFERENCE CHARACTERS

1 electrical fill level measuring device
10 probe
11 first probe part
11.1 engagement surface
11.2 socket
11.21 second probe part directed side of the socket
11.3 conical exterior surface
12 second probe part
12.1 coating
12.2 end region
20 electronic measuring/operating circuit
30 housing
40 process connection
41 open end
42 lumen
43 interior surface
50 conical seal
60 spring mechanism
61 helical spring
70 plastic part
71 conical interior surface
80 clamping apparatus
M medium
B containment

1. Electrical fill level measuring device (1) for measuring a fill level of a medium (M) in a containment (B), comprising:
an electrically conductive probe (10) adapted for conducting an electric signal, wherein the probe is adapted to be immersed in the medium;
an electronic measuring/operating circuit (20) adapted for producing and evaluating electric signals as well as for providing fill level measured values;
a housing (30), in which, for example, the electronic measuring/operating circuit is arranged;
secured to the housing, a process connection (40), which is adapted to support the probe radially, wherein the probe extends sectionally inwardly via an open end (41) of the process connection into a lumen (42) of the process connection;
wherein the probe (10) is supported radially by the process connection by means of a conical seal (50),
wherein an interior surface (43) of the process connection in the region of the open end has a conical form, wherein an inner diameter decreases toward the open end, wherein the conical seal is compressed between the conical interior surface and the probe,
wherein a spring mechanism (60) is adapted to push against the conical seal axially in the direction of the open end,
characterized in that
the probe has a first probe part (11) and a second probe part (12), which probe parts are joined together, wherein the first probe part is arranged in the lumen and provides an engagement surface (11.1) for the spring mechanism, and wherein the second probe part is adapted to be immersed in the medium.

2. Fill level measuring device as claimed in claim 1,
wherein the first probe part (11) is a mechanically rigid part, for example, a turned part,
wherein the second probe part (12) includes a rod, on which especially a cable is secured on a medium facing end.

3. Fill level measuring device as claimed in claim 1 or 2,
wherein the second probe part (12) has, at least sectionally, an electrically insulating coating (12.1), especially an extruded plastics coating.

4. Fill level measuring device as claimed in one of the preceding claims,
wherein the electronic measuring/operating circuit (20) is adapted to derive the fill level of the medium from a measured electric current, or a measured capacitance or a signal travel time of an electric pulse.

5. Fill level measuring device as claimed in one of the preceding claims,
wherein the first probe part (11) and the second probe part (12) are welded together, especially by means of a spot welding method.

6. Fill level measuring device as claimed in one of the preceding claims,
wherein the first probe part (11) has a socket (11.2) for the second probe part (12), which grips the second probe part in an end region (12.2) of the second probe part.

7. Fill level measuring device as claimed in claim 6,
wherein the socket (11.2) provides the engagement surface (11.1) on a side (11.21) facing the second probe part (12).

8. Fill level measuring device as claimed in one of the preceding claims,
wherein the first probe part is supported radially by the process connection (40), especially free of play, by means of a plastic part (70).

9. Fill level measuring device as claimed in claim 8,
wherein the first probe part has sectionally a conical exterior surface, wherein the plastic part (70) has a corresponding conical interior surface, wherein the exterior surface and the interior surface bear against one another by means of a force action.

10. Fill level measuring device as claimed in one of the preceding claims,
wherein the electronic measuring/operating circuit (20) is connected with the first probe part (11) by means of an electrically conductive clamping apparatus (80).

11. Fill level measuring device as claimed in one of the preceding claims,
wherein the conical seal comprises an elastomer or thermoplastic and/or is made of an elastomer or thermoplastic.
